(19) United States
(12) Patent Application Publication
(10) Pub. No.: US 2026/0001479 A1
(43) Pub. Date: Jan. 1, 2026

(54) Automobile Brake Taillight Device Capable of Displaying Braking Intensity

(71) Applicant: Zhenkun Zack Wang, Cambridge, MA (US)

(72) Inventor: Zhenkun Zack Wang, Cambridge, MA (US)

(21) Appl. No.: 19/260,503

(22) Filed: Jul. 6, 2025

(30) Foreign Application Priority Data
Jun. 25, 2022 (WO) PCT/CN2022/101348

(51) Int. Cl. B60Q 1/44

(52) U.S. Cl. CPC B60Q 1/444

(57) ABSTRACT

Existing automobile taillights integrate turn signals, running lights, and brake lights. This invention separates the brake light therefrom and adds a separate brake light. Viewed from the rear of the automobile, one brake light device is added on each side between the license plate and the existing taillight, one on the left and one on the right. This brake light is a triangle with a warning function. Eight rows of circular hole lights are uniformly distributed within the triangle, with every two rows forming one group, totaling four groups. Depending on the different braking force, this brake light will display different illumination levels from bottom to top. All four groups being fully illuminated corresponds to the heaviest brake pedal depression level. From heavy to light, the next level is the lower three groups of lights illuminating, followed by the lower two groups illuminating, and sequentially the bottommost one group illuminating. In this way, the following vehicle can perform reasonable braking on its own vehicle according to the illumination level of the leading vehicle's brake light, thereby avoiding excessive or insufficient braking operations, reducing safety accidents, and improving driving efficiency.

### TECHNICAL FIELD

The present invention relates to the design and manufacturing field of an automobile brake taillight device.

### BACKGROUND TECHNOLOGY

Automobiles have become an increasingly popular means of transportation in people's lives. In the endless stream of traffic, it often occurs that the following distance is difficult to grasp. Following too closely raises concerns about the leading vehicle suddenly braking, causing collision accidents: following too far away often results in vehicles from adjacent lanes cutting in, affecting driving speed and increasing risks. These issues arise because the following driver does not know when the leading vehicle will brake or how heavily it will brake. If information about the leading vehicle's braking could be easily obtained, traffic accidents would be greatly reduced and driving efficiency improved. The present invention is designed to address this situation.

### SUMMARY OF THE INVENTION

Existing automobile taillights integrate turn signals, running lights, and brake lights. This invention separates the brake light therefrom and adds a separate brake light. Viewed from the rear of the automobile, the layout retains the existing lights in their original positions on both sides, with the automobile license plate still placed in the middle. One brake light device is added on each side between the license plate and the existing taillight, one on the left and one on the right. This brake light is a triangle with a warning function. Eight rows of circular hole lights are uniformly distributed within the triangle, with every two rows forming one group, totaling four groups. Depending on the different braking force, this brake light will display different illumination levels from bottom to top. All four groups being fully illuminated corresponds to the heaviest brake pedal depression level. From heavy to light, the next level is the lower three groups of lights illuminating, followed by the lower two groups illuminating, and sequentially the bottommost one group illuminating. In this way, the following vehicle can perform reasonable braking on its own vehicle according to the illumination level of the leading vehicle's brake light,
thereby avoiding excessive or insufficient braking operations, reducing safety accidents, and improving driving efficiency.

### DESCRIPTION OF THE DRAWINGS

FIG. 1 is a schematic diagram of the whole vehicle equipped with the automobile brake taillight device capable of displaying braking intensity.

FIG. 2 is a schematic side view of the specific display of the automobile brake taillight device capable of displaying braking intensity.

FIG. 3 is a schematic rear view of the specific display of the automobile brake taillight device capable of displaying braking intensity.

### DETAILED DESCRIPTION OF THE EMBODIMENTS

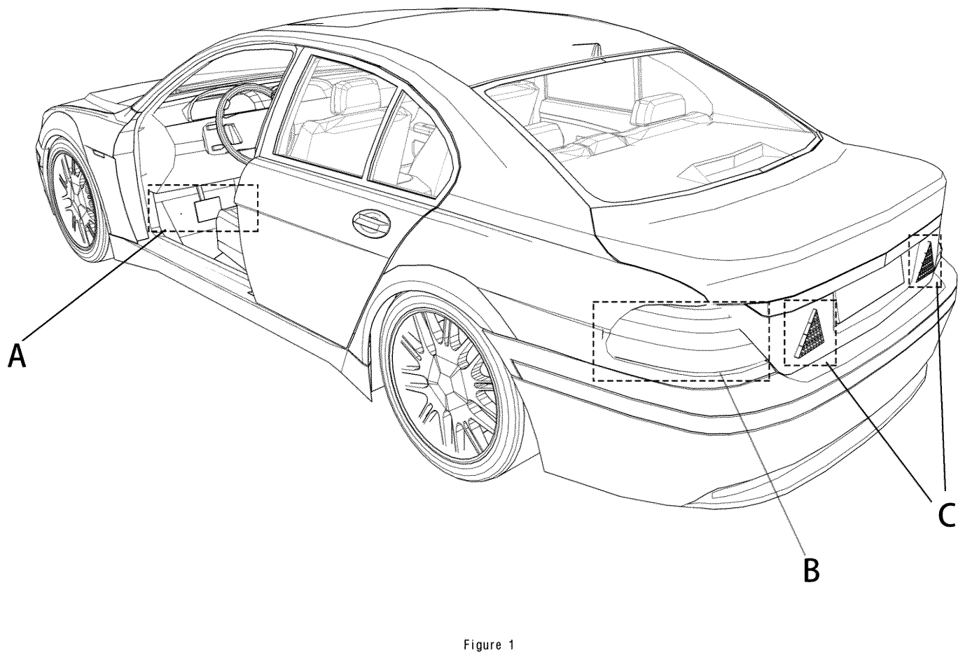

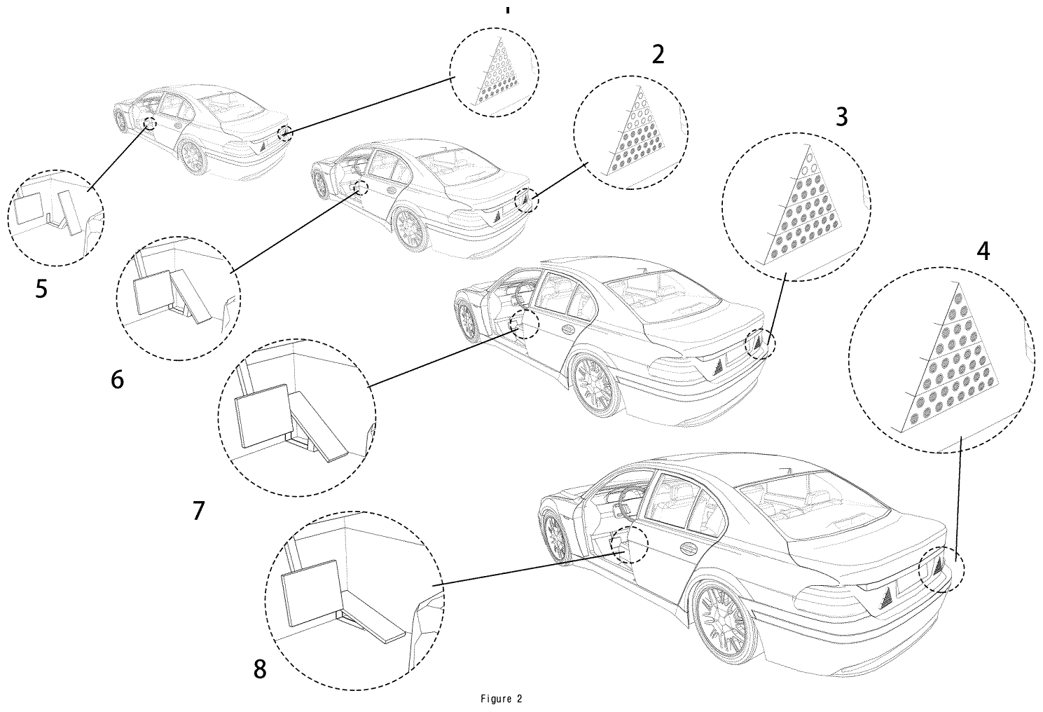

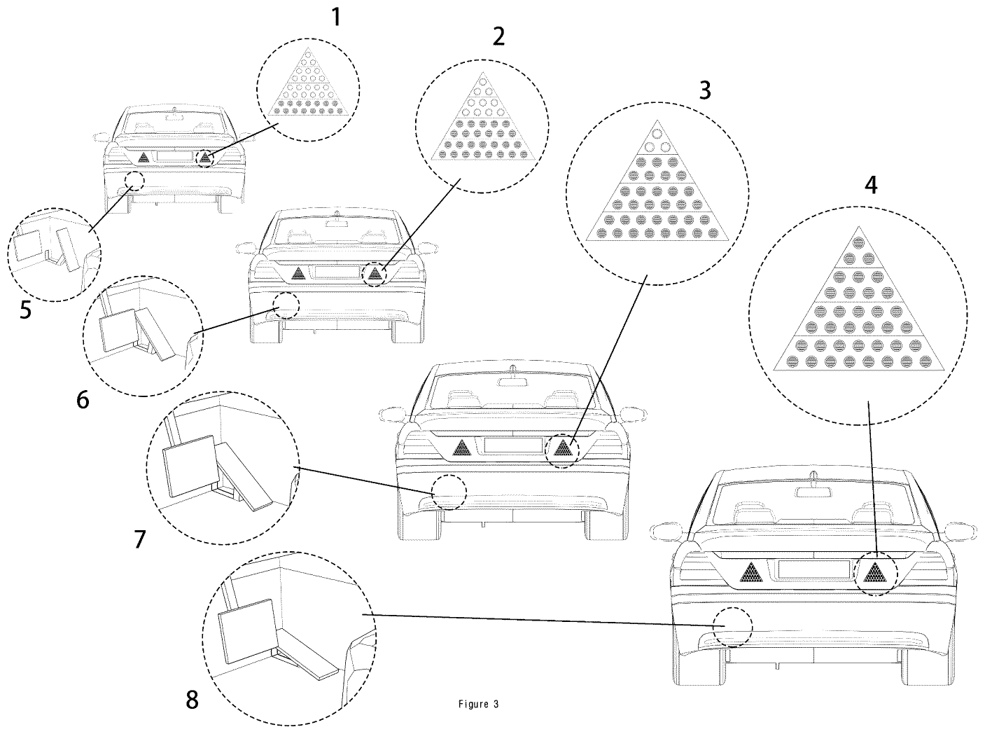

To further understand the technical solution of the present utility model, it will be further described in conjunction with the drawings.
1. From FIG. 1, the whole vehicle equipped with the automobile brake taillight device capable of displaying braking intensity can be seen. A is the braking device, B is the existing taillight, C is the newly added automobile brake taillight device capable of displaying braking intensity according to the present invention, located between the existing tail light and the automobile license plate, one on each side.
2. FIG. 2 is a schematic side view of the specific display of the automobile brake taillight device capable of displaying braking intensity. 1 is when depressing the brake pedal 5 with a lighter force, only the bottommost 2 groups of the brake light illuminate; 2 is when depressing the brake pedal 6 with a larger force, only the bottommost 4 groups of the brake light illuminate; 3 is when depressing the brake pedal 7 with an even larger force, 6 groups of the brake light illuminate from bottom to top; 4 is when depressing the brake pedal 8 with the maximum force, all 8 groups of the brake light illuminate.
3. FIG. 3 is a schematic rear view of the specific display of the automobile brake taillight device capable of displaying braking intensity. 1 is when depressing the brake pedal 5 with a lighter force, only the bottommost 2 groups of the brake light illuminate; 2 is when depressing the brake pedal 6 with a larger force, only the bottommost 4 groups of the brake light illuminate; 3 is when depressing the brake pedal 7 with an even larger force, 6 groups of the brake light illuminate from bottom to top; 4 is when depressing the brake pedal 8 with the maximum force, all 8 groups of the brake light illuminate.

The above description of the disclosed embodiments enables those skilled in the art to make or use the utility model. Various modifications to these embodiments will be readily apparent to those skilled in the art. The general principles defined herein may be applied to other embodiments without departing from the spirit or scope of the utility model. Therefore, the utility model is not intended to be limited to the embodiments shown herein but is to be accorded the widest scope consistent with the principles and novel features disclosed herein.

1. An automobile taillight device capable of displaying braking intensity, characterized in that: two triangular automobile taillights capable of displaying braking intensity are added to the rear of the automobile. Eight rows of circular hole lights are uniformly distributed within the triangle, located between the existing taillights and the automobile license plate. According to the force of depressing the brake pedal, it is divided into 4 levels. Levels 1-4 correspond from weak to strong, and the brake light illuminates sequentially from bottom to top.

2. The automobile tail light device capable of displaying braking intensity according to claim 1, characterized in that: when the brake pedal depression is weakest, the bottommost 2 groups of lights of this set of brake lights illuminate; when the brake pedal depression is slightly stronger, the bottommost 4 groups of lights of this set of brake lights illuminate; when the brake pedal depression is stronger still, the bottommost 6 groups of lights of this set of brake lights illuminate; when the brake pedal depression is strongest, all 8 groups of lights of this set of brake lights illuminate.
